(19) United States
(12) Patent Application Publication
(10) Pub. No.: US 2012/0005907 A1
(43) Pub. Date: Jan. 12, 2012

(54) CAN OPENER

(76) Inventor: Christopher John PEEDELL, St. Leonards-On-Sea (GB)

(21) Appl. No.: 13/020,765

(22) Filed: Feb. 3, 2011

(30) Foreign Application Priority Data
Feb. 4, 2010 (GB) GB1001803.4
Mar. 29, 2010 (GB) GB1005244.7

(51) Int. Cl. B67B 7/72

(52) U.S. Cl. 30/418

(57) ABSTRACT

A can opener having a body having an elongate stem, a handle, a circular blade mounted for rotation relative to the body and a drive wheel which is rotatable by the handle. The drive wheel is movable towards and away from the circular blade to selectively grip and release a portion of the can positioned between the blade and the drive wheel. The can opener is further provided with a lock operable to maintain the drive wheel in a predetermined position relative to the blade when said portion of a can is gripped between the blade and drive wheel. The blade and drive wheel, in use, grip the raised peripheral rim of the can which projects upwardly from the lid of the can.

### PRIORITY

This application claims the benefit of priority under 35 U.S.C. 119 of British Patent Application Nos. GB 1001803.4 filed 4 Feb. 2010 and GB 1005 244.7 filed 29 Mar. 2010, the entirety of which are incorporated by reference in their entirety.

### TECHNICAL FIELD

The present invention relates to a can opener of the type used in catering establishments to open large diameter cans of produce, cooking ingredients and the like.

A typical catering type can opener is provided with a downwardly depending blade which, in use, pierces the top of a can. The blade can thus come into contact with the contents of the can during the opening operation. It is an object of the present invention to minimise the penetration of the blade into a can during the opening thereof.

### SUMMARY OF THE INVENTION

According to a first aspect of the present invention there is provided a can opener having a body having an elongate stem, a handle, a circular blade mounted for rotation relative to the body and a drive wheel which is rotatable by the handle, wherein the drive wheel is movable towards and away from the circular blade to selectively grip and release a portion of the can positioned between the blade and the drive wheel, wherein the can opener is further provided with a lock operable to maintain the drive wheel in a predetermined position relative to the blade when said portion of a can is gripped between the blade and drive wheel, wherein the blade and drive wheel, in use, grip the raised peripheral rim of the can which projects upwardly from the lid of the can.

In a preferred embodiment the drive wheel is pivotable relative to the blade. In such an embodiment the drive wheel may be provided in a first portion of the body and the blade in a second portion of the body, wherein one of the body portions is pivotable relative to the other. Preferably the body portion having the drive wheel is pivotable relative to the body portion having the blade. In such an embodiment the body portion having the drive wheel may be pivotable about an axis that is substantially perpendicular to the longitudinal axis of the stem of the body.

The lock may comprise a locking pin carried by one of the body portions which interacts with a locking formation of the other of the body portions. In such an embodiment the locking pin may be received in a recess or aperture of the other of the body portions. The locking pin is preferably urged in the direction of the formation. In such an embodiment the locking pin may be urged by a coil spring or like resilient means. The lock is preferably provided with an actuator operable to disengage the locking pin from the locking formation. The actuator may include a member which is movable by a user of the can opener. The member may comprise a button which is movable by the user. The button may act on the locking pin to move the locking pin in a direction away from the locking formation.

According to a further aspect of the present invention there is provided a can opener having a body, a handle, a circular blade mounted for rotation on a blade carrier which is movably mounted to the body and a drive wheel rotatable by the handle, wherein the blade carrier is movable towards and away from the drive wheel to selectively grip and release a portion of a can positioned between the blade and drive wheel, wherein the can opener is further provided with a lock operable to maintain the blade carrier in a predetermined position when said portion of a can is gripped between the blade and drive wheel, wherein the blade and drive wheel, in use, grip the raised peripheral rim of the can which projects upwardly from the lid of the can.

By gripping the raised rim between the blade and drive wheel, the blade penetrates the rim at a position above the level of the top of the can. The rim comprises the seam where the cylindrical body of the can is joined to the circular lid of the can. The blade thus cuts into the seam and does not penetrate into the interior of the can. The lock ensures that blade remains in contact with the can during rotation thereof.

The lock may comprise a bearing member which is movable into engagement with the blade carrier to prevent movement thereof from the predetermined position. The bearing member may be mounted for rotation such that rotation thereof in a first direction moves the bearing member into engagement with the blade carrier and rotation in a second direction moves the bearing member out of engagement with the blade carrier. The bearing member may preferably be provided with a threaded portion which is received in a complementarily threaded aperture of the base. The threaded aperture may be provided in a plate or like member which is attached to the body. The bearing member may preferably be movable via an actuation member which is provided to the exterior of the body. The actuation member may be rotatable through an arc of approximately 270 degrees to move the bearing member between the engaged and disengaged positions with the blade carrier.

The blade is rotatable about a blade axis of rotation and the drive wheel is rotatable about drive wheel axis of rotation wherein the blade axis of rotation is inclined to the drive wheel axis of rotation. The blade carrier is preferably pivotably mounted to the can opener body. The blade carrier is preferably pivoted by movement of the handle.

### BRIEF DESCRIPTION OF THE DRAWINGS

Embodiments of the present invention will now be described with reference to the accompanying drawings in which:

FIG. 1 shows a perspective view of a can opener according to a first embodiment the present invention;

FIG. 2 shows a further perspective view of the can opener of FIG. 1;

FIG. 3 shows a rear view of the head of the can opener of FIG. 1;

FIG. 4 shows the cross-sectional view indicated by arrows A-A on FIG. 3;

FIG. 5 shows a further rear view of the head of the can opener of FIG. 1;

FIG. 6 shows the cross-sectional view indicated by arrows A-A on FIG. 5;

FIG. 7 shows a further rear view of the head of the can opener of FIG. 1;

FIG. 8 shows the cross-sectional view indicated by arrows A-A on FIG. 7;

FIGS. 9, 10 and 11 show, respectively, side, front and bottom plan views of the blade and blade carrier of the can opener;

FIG. 12 shows a perspective view of a can opener according to a further embodiment of the present invention;

FIG. 13 shows a further perspective view of the can opener of FIG. 12;

FIG. 14 shows a cross-sectional view of the can opener of FIG. 12; and

FIG. 15 shows a perspective view of a detent mechanism of the can opener of FIG. 12.

### DETAILED DESCRIPTION OF THE DRAWINGS

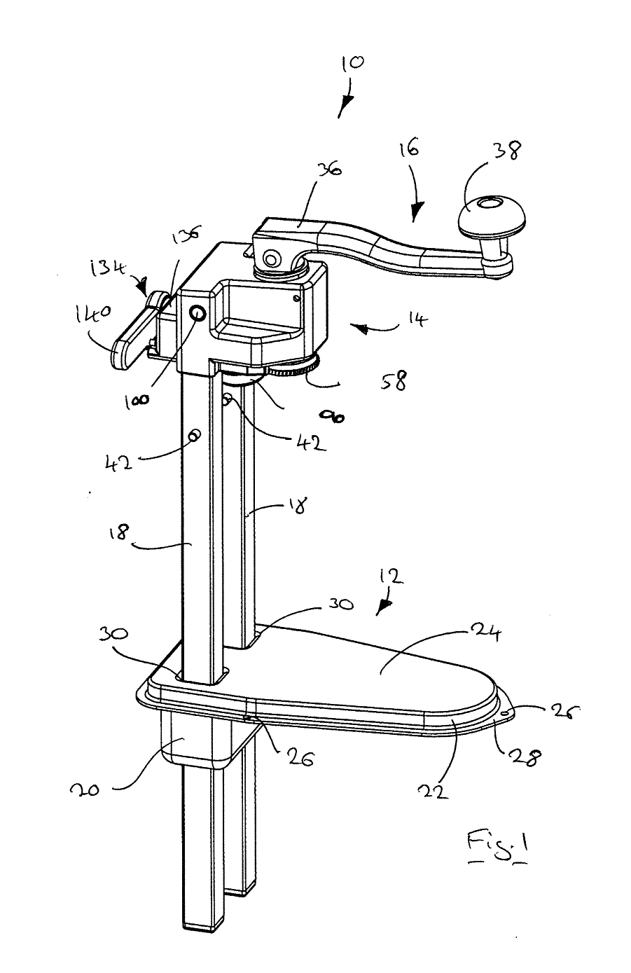

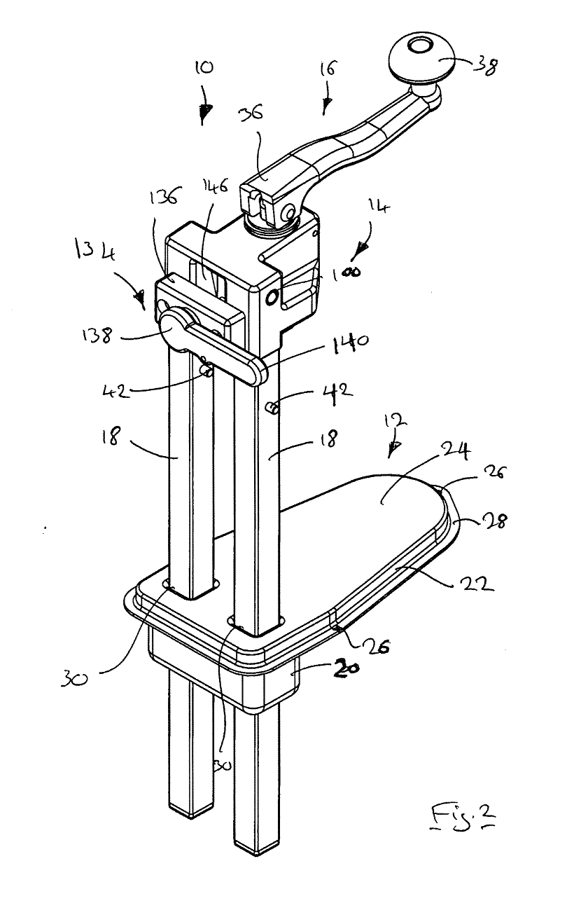

Referring firstly to FIGS. 1 and 2 there is shown a can opener generally designated 10. The can opener 10 includes a base 12, a head 14, a handle 16 and a pair of stem tubes 18. The base 12 comprises a base block 20 and a base cover 22. The base 12 enables the can opener 10 to be mounted to a work surface, for example the edge of table. The base 12 may, for example, be mounted to the surface by the use of fasteners which pass through apertures 26 provided in a peripheral flange 28 of the base cover 22. Alternatively, the base block 20 may be provided with a clamp assembly (not shown) which, in use, is operable to clamp the base 12 to a work surface. The base cover 22 further defines a support surface 24 upon which a can, in use, is supported while being opened. The base block 20 and base cover 22 are provided with aligned apertures 30 through which the stem tubes 18 are slidably received.

The head 14 of the can opener 10 is provided with a drive wheel 58 and a blade 90 which will be described in greater detail below. The drive wheel 58 is rotatable by rotation of the handle 16. The handle 16 comprises an arm 36 and a knob 38, with the knob 38 being rotatably mounted to the arm 36. The head 14 is further provided with a lock generally designated 134 which too will be described in greater detail below. The stem tubes 18 are connected to the head 14 by pins 42 which extend through aligned apertures of the tubes 18 and corresponding projections of the head 14. Each pin 42 extends from opposing sides of its respective stem tube 18. The pins 42 thus limit the distance by which the stem tubes 18 can descend through the apertures 30 of the base 12.

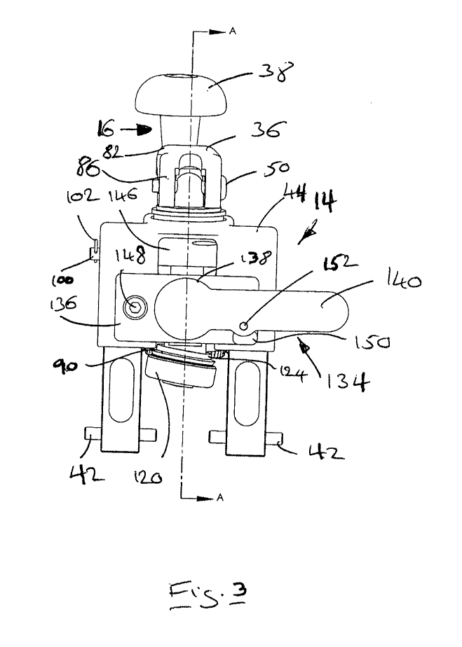

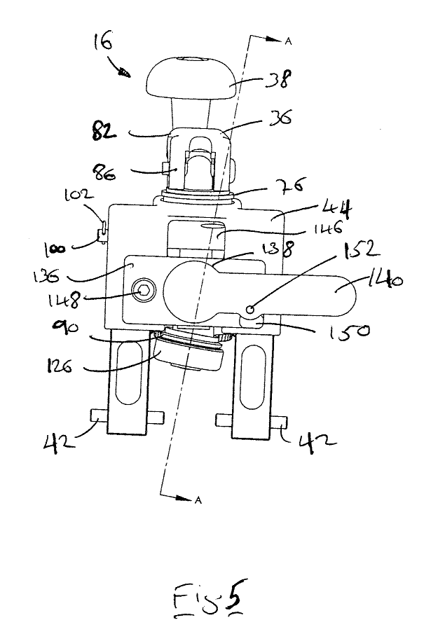

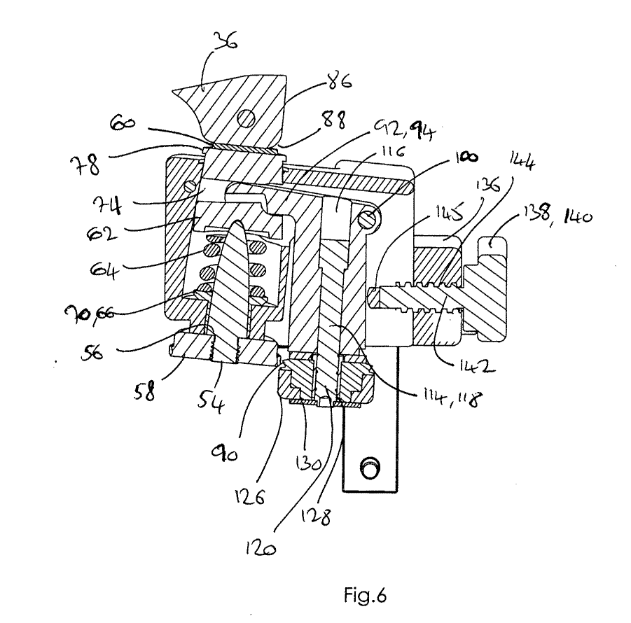

Referring now to FIGS. 3 to 11, the head 14 and its internal components can be seen in greater detail. The head 14 includes a body 44 having a cavity 46 within which said internal components are provided.

The arm 36 of the handle 16 is pivotally connected to a drive shaft 48 by a pin 50. The drive shaft 48 extends into the cavity 46 of the body 44 through an upper aperture 52 in the body 44. The end 54 of the drive shaft 48 which is distal to the handle arm 36 extends form the cavity 46 to the exterior of the body 44 through a lower aperture 56 in the body 44. The distal end 54 of the drive shaft 48 is threaded and, in use, is received in a complementarily threaded through aperture of a toothed drive wheel 58. Intermediate the handle arm 36 and the drive wheel 58 there are provided a washer 60, a collar 62, a coil spring 64 and a bush 66.

The bush 66 is cylindrical having a central aperture through which the drive shaft 48 extends. The bush 66 has a smaller diameter portion 68 which extends into lower aperture 56 of the body 44 and a larger diameter portion 70 which is fully provided within the cavity 46 and which functions as a lower seat for the coil spring 64. The collar 62 is generally cylindrical and has a central aperture though which the drive shaft 48 extends. The underside of the collar 62 is provided with a cylindrical recess 72 which functions as an upper seat for the coil spring 64. The collar 62 is further provided with cut-out 74 in the side wall 76 thereof which, in use, receives spaced arms 94 of a blade carrier 92 of the can opener 10. The interaction of the collar 62 with the blade carrier 92 will be described in greater detail below. The collar 62 is further provided with a peripheral flange 78 which, in use, limits the distance by which the collar 62 can be moved into the cavity 46 against the bias of the coil spring 64. The washer 60 is positioned between the collar 62 and the handle arm 36.

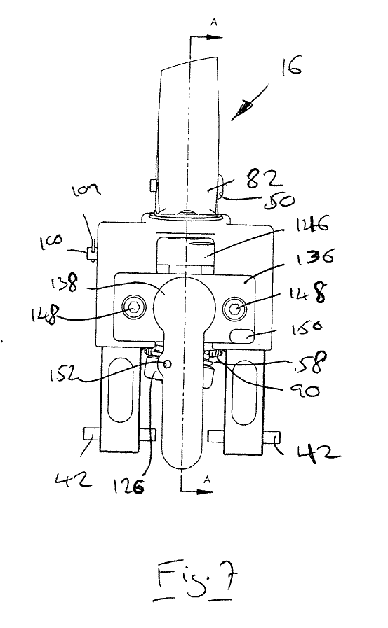

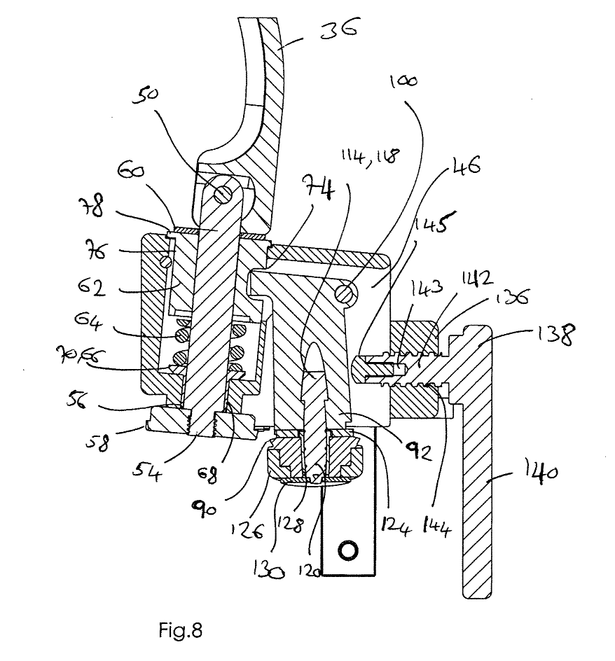

The end 82 of the handle arm 36 proximal to the drive shaft 48 is provided with first and second planar abutment surfaces 84,86. The plane of the first surface 84 is substantially normal to the plane of the second surface 86. A rounded transition surface 88 is provided between the first and second abutment surfaces 84,86. The handle 16 is pivotable about the pin 50 between a first or lowered position where the first abutment surface 84 contacts the washer 60 and a second or raised position where the second abutment surface 86 contacts the washer 60. The first position of the handle 16 is shown in FIGS. 1 to 6 and the second position of the handle 16 is shown in FIGS. 7 and 8. The end 82 of the handle arm 36 is configured such that the first abutment surface 84 is a first distance from the pin 50 and the second abutment surface 86 a second distance from the pin 50, the second distance being greater that the first distance. The movement of the handle 16 from the first position to the second position thus results in movement of the collar 62 into the cavity 46 and compression of the coil spring 64. Movement of the handle 16 in the opposite direction has the opposite result. In the embodiment shown the first distance is approximately 9.5 mm and the second distance approximately 12.7 mm, with the result that the collar 62 is movable a distance of 3.2 mm along the drive shaft 48. It will be appreciated that, by virtue of the presence of the arms 94 in the cut out 74 of the collar 62, axial movement of the collar 62 results in pivoting movement of the blade carrier

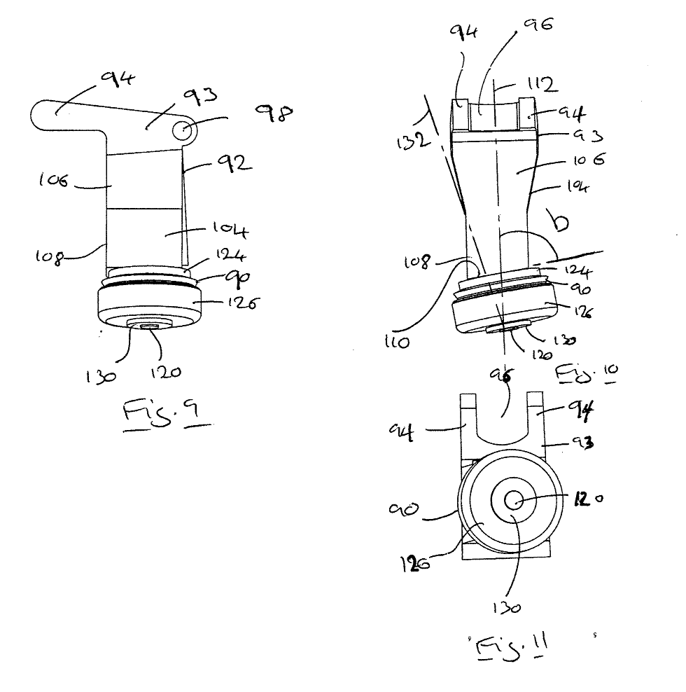

The body 44 is further provided with a circular blade 90 and a blade carrier 92. The blade carrier 92 is shown in greater detail in FIGS. 9 to 11. The blade carrier 92 is provided at an upper region 93 thereof with a pair of arms 94 between which there is provided a recess 96. The upper region 93 of the blade carrier 92 is further provided with a through aperture 98 which extends through the blade carrier 92 in a direction which is transverse to the longitudinal axes of the arms 94. The through aperture 98 permits the blade carrier 92 to be pivotably mounted within the body cavity 46. In the embodiment shown the blade carrier 92 is pivotably mounted within the body cavity 46 by a pin 100. The pin 100, in use, extends through aligned apertures in opposing sides of the body 44 and through the through aperture 98 of the blade carrier 92. The pin 100 is removable so as to enable the blade carrier 92 to be removed from the body 44. The pin 100 is secured against accidental or unintentional removal by a spring clip 102.

The blade carrier 92 is further includes a leg 104 which extends from the upper region 93. The leg 104 has an upper portion 106 and a lower portion 108, with the upper portion 106 tapering from the upper region 93 to the lower portion 108. The leg 94 terminates at an inclined face 110. The face 110 is inclined at an angle b to the longitudinal centreline axis 112 of the leg 104. The angle b may be approximately 81 degrees, +/−0.25 degrees.

The circular blade 90 is rotationally mounted to a post 114 which is carried by the leg 104 and which extends from the inclined face 110 thereof. The post 114 is received in a through aperture 116 of the leg 104. The post 114 is provided with a head 118 and a shank 120. The underside of the head 118, in use, abuts an annular step 122 of the through aperture 116 and thereby limits the distance by which the shank 120 is able to project from the inclined face 110. The circular blade 90 is provided between an annular spacer 124 and an annular can control bush 126. The blade 90, spacer 124 and bush 126 are in turn provided upon a sleeve 128 through which the shank 120 of the post 114 passes. The sleeve 128 is retained to the shank 120 by a retaining washer 130. It will be understood that the blade 90, spacer 124 and bush 126 are rotationally mounted to the post 114 and that the axis of rotation 132 of the blade 90, spacer 124 and bush 126 is normal to the plane of the inclined face 110.

The head 14 is further provided with a lock generally designated 134. The lock 134 comprises lock plate 136 and a lock member 138. The lock member 138 includes a handle 140 and a threaded stem 142. The end of the threaded stern 142 is provided with a threaded aperture 143 within which there is provided a threaded insert 145. The threaded stem 142 is received in a complementarily threaded through aperture 144 of the lock plate 136. The lock plate 136 is connected to a rear face of the body 44 across an aperture 146 in said rear face. The lock plate 136 is connected to the body 44 by threaded fasteners 148. The lock plate 136 is further provided with a stop projection 150 which co-operates with a projection 152 of the lock member handle 140 to limit the position to which the threaded stem 142 can be moved through the threaded aperture 144 of the lock plate 136.

The lock 134 is movable between a first or open position shown in FIGS. 7 and 8, and a second or closed position shown in FIGS. 1 to 6. In the closed position the insert 145 of the lock member 138 abuts the blade carrier 92 and thus resists pivotal movement of the blade carrier 92 away from the drive wheel 58. In the closed position the projection 152 of the lock member handle 140 rests against the stop projection 150. The purpose of the lock 134 is to prevent movement of the blade carrier 92 away from the drive wheel 58 during a can opening operation which could result in cessation of can rotation and/or disengagement of the cutting blade 90 from the can.

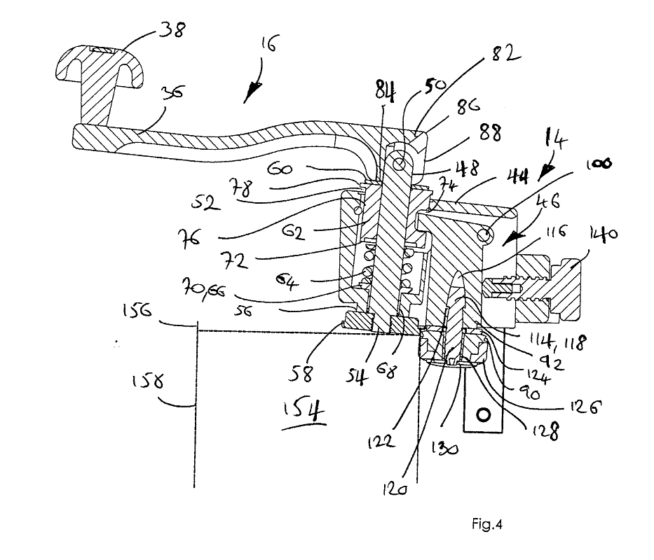

Operation of the can opener will now be described. With the can opener 10 in the initial position shown in FIGS. 7 and 8, i.e. with the handle 16 raised and the lock 134 in the open position, a can 154 (shown in broken lines in FIG. 4) is placed on the base cover 22 and the head 14 lowered such that the raised rim 156 of the can 154 is received between the drive wheel 58 and blade 90. The cutting edge of the blade 90 is provided a height on the wall 158 of the can 154 which is above the level of the top face 160 of the can 154 such that it faces the raised rim 156. The handle 16 is then moved to the lowered position such that the blade carrier 92 is pivoted towards the drive wheel 58 and the can 154 is gripped between the drive wheel 58 on one side and the blade 90 and can control bush 126. Movement of the handle 16 to the lowered position also causes the blade 90 to cut into the raised rim 156 of the can 154. The cut depth is sufficient to penetrate the outer layer of rim 156 which forms part of the seam between the cylindrical body of the can and the circular lid of the can. As the cut is made into the rim above the level of the top face 160 it will be appreciated that no penetration into the interior of the can 154 is made. The lock 134 is then moved to the closed position so as to maintain the blade carrier 92 in position.

It will be understood that drive wheel 58 is in driving engagement with the raised rim 156 of the can 154, and that the can control bush 126 is in driven engagement with the wall 158 of the can 154. Rotation of the handle 16 results in rotation of the drive wheel 58 which, in turn rotates the can 154. Rotation of the can 154 causes rotation of the can control bush 126 and blade 90. An incision in the rim 156 of the can 154 around its circumference is thus made as the can 154 and blade 90 rotate relative to one another. The incision thus fully extends around the circumference of the can 154 after the can 154 has completed a single rotation, and the opened can be removed from the base cover 22 leaving the removed top of the can gripped between the drive wheel 58 and blade 90. The top is removable from the drive wheel 58 and blade 90 by moving the lock 134 to the open position and the handle 16 to the raised position.

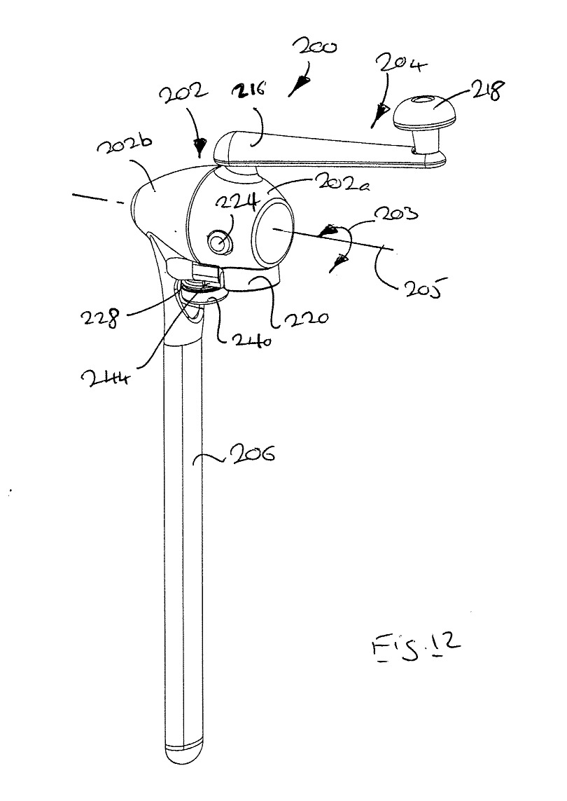

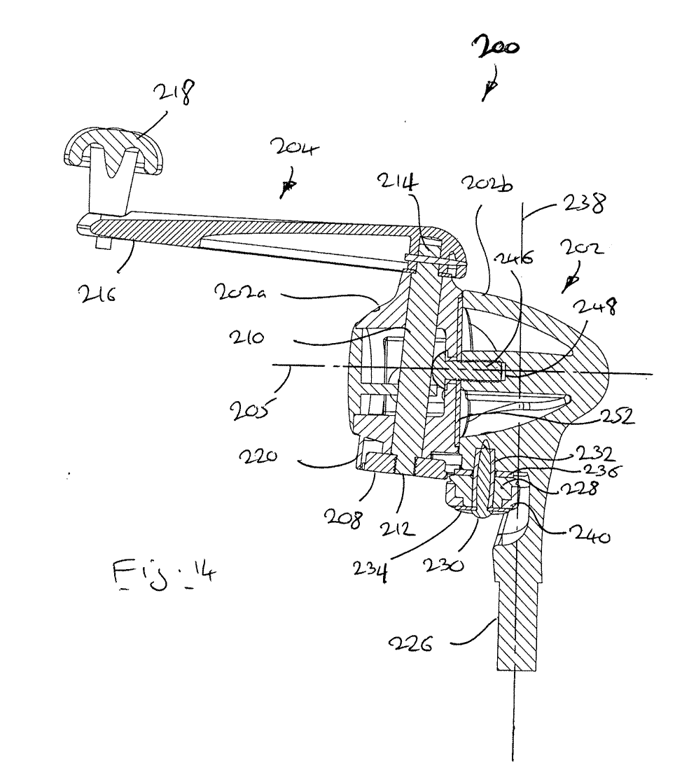

Referring now to FIGS. 12 to 15 there is shown an alternative embodiment of a can opener generally designated 200. The opener 200 includes a head 202, a handle 204 and a stem tube 206. In use, the stem tube 206 fits to a base (not shown) which is similar to the base 12 described with reference to the FIGS. 1 to 11. The base for the opener 200 of FIGS. 12 to 15 differs in that it is provided with a single aperture for the stem tube 206.

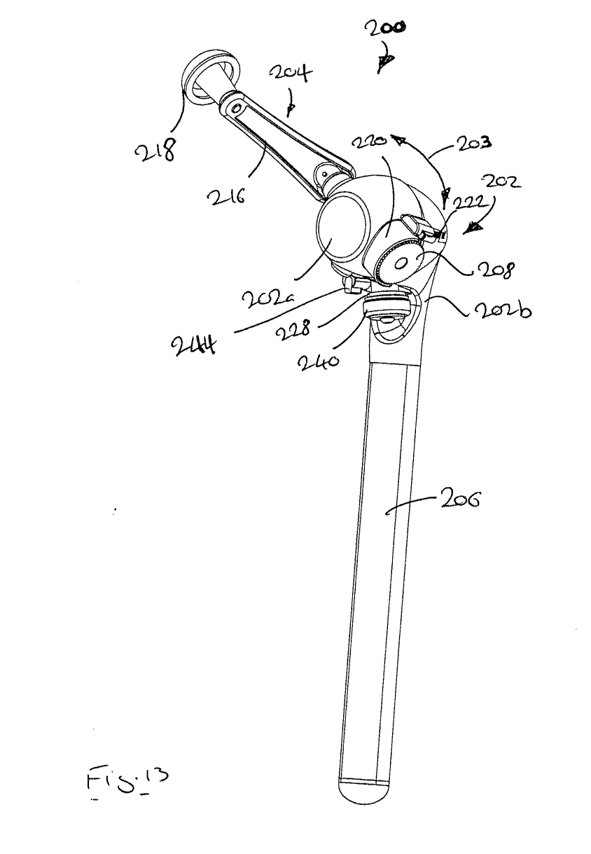

The head 202 includes a front portion 202a and a rear portion 202b. The front portion 202a of the head 202 is pivotably connected to the rear portion 202b of the head 202 as will be described in greater detail below. The front portion 202a is pivotable between an open position shown in FIG. 12 and a closed position shown in FIG. 13 as indicated by arrow 203. The front portion 202a is pivotable about an axis 205 that is substantially perpendicular to the longitudinal axis 238 of the stem tube 206.

The front portion 202a of the head 202 comprises a body which supports the handle 204 and a toothed drive wheel 208. The handle 204 and drive wheel 208 are connected by a drive shaft 210 which extends through the front portion 202a. The end 212 of the drive shaft 210 which is distal to the handle 204 is threaded and is received in a complimentarily threaded through aperture of the toothed drive wheel 208. The opposite end 214 of the drive shaft 210 extends through an aperture in an upper region of the front portion 202a and provides a location at which the handle 204 connects to the drive shaft 210. The handle 204 comprises an arm 216 and a knob 218, wherein the knob 218 is rotatably mounted to the arm 216. It will be appreciated that, in the same manner as for the can opener 10 described with reference to FIGS. 1 to 11, rotation of the handle 204 results in corresponding rotation of the drive wheel 208.

The front portion 202a of the head 202 is further provided with a curved shroud 220 which partially surrounds the drive wheel 208. The front portion 202 of the head 202 is further provided with a wear pin 222 which is provided to one side of the drive wheel 208. The wear pin 222 is located on a recess of the head front portion 202a and is comprised of metal. The wear pin 222, in use, abuts the raised rim of a can while it is opened by the can opener 200. It will be appreciated that during opening of a can that the can is rotated relative to the can opener and thus there is rubbing contact between the can rim and the wear pin 222. The wear pin 222 is sacrificial and may be replaced during the life of the can opener 200.

The front portion 202a of the head 202 is further provided with an actuation button 224. The actuation button 224 is operable to facilitate pivoting of the front portion 202a of the head 202 relative to the rear portion 202b of the head 202 as will be described in greater detail below. The actuation button 224 extends through an aperture in the front portion 202a of the head 202.

The rear portion 202b of the head 202 is provided with a lower projection 226 which, in use is received within a hollow interior of the stem tube 206. The rear portion 202b is further provided with a circular blade 228. The blade 228 is rotatably mounted to the rear portion 202b by a threaded fastener 230 which, in use, passes through an aperture in the centre of the blade 228 and is received in a complementarily threaded recess of the rear portion 202b. A sleeve 232 is provided between the blade 228 and the threaded fastener 230. Washers 234,236 are provided on opposing sides of the blade 228.

The blade 228 is further provided with a peripheral can support surface 240 which, in use, contacts the side of a can while it is being opened. The peripheral support surface 240 may be provided upon an annular member 242 which is fitted to the blade 228. The annular member 242 is provided with a recess into which a portion of the blade 228 is received. The blade portion and recess into which it is received are complimentarily shaped so that the annular member 242 is coupled for rotation with the blade 228.

The rotational axis of the circular blade 228 is inclined relative to the longitudinal axis 238 of the lower projection 226 and stem tube 206 in a similar manner to that shown in FIG. 10 for the can opener 10 described above. The rotational axis of the circular blade 228 is thus inclined approximately 9 degrees, +/−0.25 degrees to the longitudinal axis 238.

The rear portion 202b of the head 202 is further provided with a wear pin 244. The wear pin 244 is received in a recess of the rear portion 202b and, in use, abuts the rim of a can as it is opened by the opener 200. The rear portion wear pin 244 is provided on an opposite side of the head 202 to the front portion wear pin 222 such that when the can opener 200 is in the closed position the wear pins 222,244 are provided on opposing sides of the drive wheel 208.

The front portion 202a of the head 202 is pivotably connected to the rear portion 202b of the head 202 by a threaded fastener 246. The threaded fastener 246 extends though an aperture of the front portion 202a and is received in a complementarily threaded blind recess 248 of the rear portion 202b.

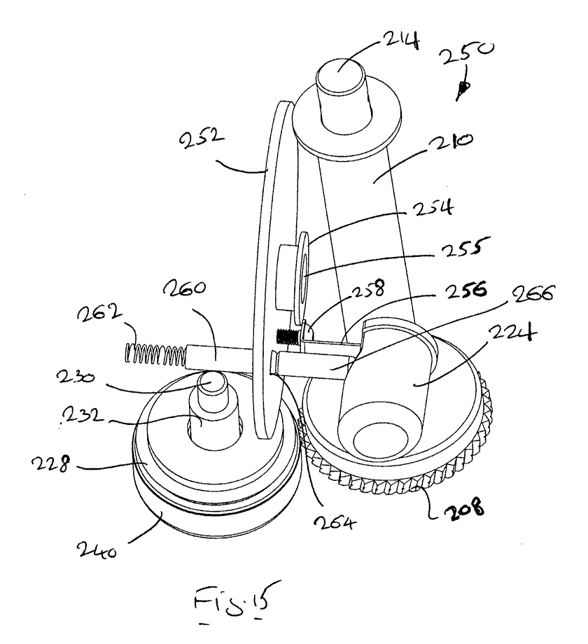

FIG. 15 shows a detent or locking mechanism generally designated 250 which is provided between the front portion 202a and the rear portion 202b and is operable to retain the opener 200 in the closed position. The detent mechanism 250 includes a circular friction plate 252 which is fixed to the front portion 202a of the head 202. The friction plate 252 is coupled for rotation with the front portion 202a and is provided with an aperture to which an annular bearing 254 is fitted. The annular bearing 254 includes an aperture 255 through which the threaded fastener 246 extends. The friction plate 252 is further provided with a leaf spring 256. The leaf spring 256 is connected to the friction plate 252 by a threaded fastener 258. The leaf spring 256 abuts the actuation button 224 and urges the actuation button 224 outwards with respect to the interior of the front portion 202a.

The detent mechanism 250 further includes a lock pin 260 which is provided in the rear portion 202b of the head 202. The lock pin 260 is acted upon by a spring 262 which urges the lock pin 260 in the direction of the front portion 202b. The friction plate 252 is provided with a locking aperture 264 within which the lock pin 260 is received when the can opener 200 is in the closed position. The reception of the lock pin 260 in the locking aperture 264 prevents the movement of the front portion 202a relative to the rear portion 202b.

The detent mechanism 250 further includes a release pin 266 which is aligned with the lock pin 260. A first end 268 of the release pin 266 abuts the lock pin 260 when it is received in the locking aperture 264, while the second end 270 of the release pin 266 abuts a ramp surface of the actuation button 224. Depression of the actuation button 224 causes the release pin 266 to move in the direction of the lock pin 260 and thereby disengage the lock pin 260 from the locking aperture 264. With the lock pin 260 disengaged from the locking aperture 264, the front portion 202a of the head 202 can be pivoted relative to the rear portion 202b away from the closed position and towards the open position.

Operation of the can opener 200 of FIGS. 12 to 14 will now be described. With the can opener 200 in the open position shown in FIG. 12, the head 202 can be lowered onto a can such that the raised rim of the can is contacted by the wear pin 244 of the rear portion 202b of the head 202. At this position the cutting edge of the blade 228 is provided a height on the wall of the can which is above the level of the top face of the can 154 such that it faces the raised rim. This positioning of the blade 228 is substantially the same as that described with reference to the embodiment of FIGS. 1 to 11. Pivoting of the front portion 202a of the head 202 to the closed position causes the drive wheel 208 to contact the opposite side of the raised rim to the blade 228 and for the rim to be gripped therebetween.

Movement of the front portion 202a to the closed position also causes the blade 228 to cut into the raised rim of the can. The cut depth is sufficient to penetrate the outer layer of rim 156 which forms part of the seam between the cylindrical body of the can and the circular lid of the can. As the cut is made into the rim above the level of the top face it will be appreciated that no penetration into the interior of the can is made. The lock pin 260 engages the locking aperture 264 of the friction plate 252 to maintain the opener 200 in the closed position. It will further be appreciated that the wear pin 222 of the front portion 202a of the head 202 is moved in to contact with the raised rim of the can when the opener 200 is in the closed position.

It will be understood that drive wheel 208 is in driving engagement with the raised rim of the can, and that the can support surface 240 of the blade 228 is in driven engagement with the wall of the can. Rotation of the handle 204 results in rotation of the drive wheel 208 which, in turn rotates the can. Rotation of the can causes rotation of the can support surface 240 and blade 228. An incision in the rim of the can around its circumference is thus made as the can and blade rotate relative to one another. The incision thus fully extends around the circumference of the can after the can has completed a single rotation, and the opened can be removed from below the opener 200 leaving the removed top of the can gripped between the drive wheel 208 and blade 228. The top is removable from the drive wheel 208 and blade 228 by depressing the actuation button 224 to disengage the lock pin 260 and then pivoting the front portion 202a of the head 200 to the open position.

What is claimed is:

1. A can opener, comprising:
a body having an elongate stem;
a handle;
a circular blade mounted for rotation relative to the body; and
a drive wheel which is rotatable by the handle,
wherein the drive wheel is movable towards and away from the circular blade to selectively grip and release a portion of the can positioned between the blade and the drive wheel,
wherein the can opener is further provided with a lock operable to maintain the drive wheel in a predetermined position relative to the blade when said portion of a can is gripped between the blade and drive wheel, and
wherein the blade and drive wheel, in use, grip the raised peripheral rim of the can which projects upwardly from the lid of the can.

2. The can opener of claim 1, wherein the drive wheel is provided in a first portion of the body and the blade in a second portion of the body, wherein one of the body portions is pivotable relative to the other.

3. The can opener of claim 2, wherein the body portion having the drive wheel is pivotable relative to the body portion having the blade.

4. The can opener of claim 3, wherein the body portion having the drive wheel is pivotable about an axis that is substantially perpendicular to the longitudinal axis of the stem of the body.

5. The can opener of claim 1, wherein the lock includes a locking pin carried by one of the body portions which interacts with a locking formation of the other of the body portions.

6. The can opener of claim 5, wherein the locking formation is a recess or aperture of the other of the body portions.

7. The can opener of claim 5, wherein the locking pin is urged in the direction of the locking formation.

8. The can opener of claim 7, wherein the locking pin is urged in the direction of the locking formation by a coil spring or like resilient means.

9. The can opener of claim 5, wherein the lock is provided with an actuator operable to disengage the locking pin from the locking formation.

10. The can opener of claim 9, wherein the actuator includes a button which is movable by a user of the can opener to act on the locking pin to move the locking pin in a direction away from the locking formation.
